(19) United States
(12) Patent Application Publication
(10) Pub. No.: US 2013/0049948 A1
(43) Pub. Date: Feb. 28, 2013

(54) COLLABORATIVE AND DISTRIBUTED ALERT MANAGEMENT SYSTEM

(71) Applicant: Junaid Ali, Lakewood, OH (US)

(72) Inventor: Junaid Ali, Lakewood, OH (US)

(21) Appl. No.: 13/592,697

(22) Filed: Aug. 23, 2012

Related U.S. Application Data
(60) Provisional application No. 61/526,391, filed on Aug. 23, 2011.

(51) Int. Cl. G08B 23/00

(52) U.S. Cl. 340/501

(57) ABSTRACT

A network based alert management system and method for managing a plurality of users, enrolled websites and a plurality of alert content items includes a network, a first database of users and enrolled websites connected to the network, and a second database of alert content items connected to the network. Each of the enrolled websites of the first database is associated with one or more alert content items of the second database. When one of the enrolled websites is accessed over the network, the one or more alert content items from the second database are presented over the network to the accessed one of the enrolled websites for viewing thereof and/or one or more alert content items is subscribed over the network to the second database through the accessed one of the enrolled websites.

This application claims the benefit of U.S. Provisional Patent Application Ser. No. 61/526,391 filed on Aug. 23, 2011, which is expressly incorporated herein by reference.

### BACKGROUND

There are many individual websites, applications and systems that provide some sort of alert functionality such that a user will get notification and information for a topic of interest. Finding reputable sources and subscribing to each for the segments that they are applicable is a tedious task for many users today. And current systems lack comprehensive functionality and consistent access and interfaces that allow users to collaborate together in distributed environments to deliver alert functionality from a central managed source. There is also a lack of managed quality through collaboration that makes it feasible for the best alert information to be disseminated without incurring huge editorial and management costs.

Websites who wish to provide simple alert services for their users cannot do so easily using the systems of today due to implementation costs and user perception and tendencies. An alert system today would cost much to first develop (or buy) and then integrate within the website. Users of the website perceive alerts services by websites in low regard than alert services delivered by a dedicated alert management system because users believe the main business of the website is not in managing alerts and they would receive low-quality alert content. Also users hold website-delivered alert services with skepticism because they do not want to manage an alert service account from the multitude of websites they visit on a regular basis. Therefore websites today have difficulty engaging their users in utilizing alerts service offered by them and also websites avoid providing the service due to the costs.

### SUMMARY

According to one aspect a system is provided for managing and delivering alerts to users. In an exemplary embodiment, experts and algorithms are enabled to provide alert information and notifications to requestors on a real-time or interval basis. Another aspect of this system can be to allow external websites and businesses to participate and provide advanced alert functionality easily to their user base. In the same or another aspect, a multi-user, multi-website and content delivery system is described that enables extensive and configurable options to help deliver quality alert information and notifications.

According to another aspect, a system for managing alert requests and fulfillments includes at least one website having website content hosted on at least one machine server and an alert management system (AMS) independent of the website and hosted on at least one server. The AMS presents alert functionality to users of the website at the time the user is accessing the website. The AMS has a database including a plurality of alerts and the database associates at least one website with AMS alert activity.

According to still another aspect, a system for managing alert requests and fulfillments includes an alert management system (AMS) hosted on at least one server. The AMS has a database including a plurality of alerts. Users of the AMS add at least one algorithm reference to the database. The algorithm reference causes an algorithm to execute on at least one alert.

According to a further aspect, a system for managing alert requests and fulfillments includes an alert management system (AMS) hosted on at least one server. The AMS has a database including a plurality of alerts. At least one expert user of the AMS adds alert fulfillment in the AMS and at least two users of the AMS rate the alert fulfillment after having received the alert fulfillment as a notification to generate a reputation for the expert user. The expert user reputation is generally visible to users of the AMS.

### BRIEF DESCRIPTION OF THE DRAWINGS

FIG. 1 is an exemplary schematic diagram showing the major entities and relationships with a alert management system (AMS).

FIG. 2 is an exemplary block diagram showing generally how users create, subscribe, fulfill and receive alerts in AMS.

FIG. 3. is an exemplary block diagram showing key components of an alert and how the various entities interact with alerts in AMS.

FIG. 4 is an exemplary block diagram showing AMS with the major entities and external website or system interactivity.

FIG. 5 is an exemplary block diagram illustrating algorithms within AMS.

FIG. 6 is a block diagram showing an exemplary method of implementing algorithms.

FIG. 7 is an information flow diagram showing exemplary relevancy capabilities of the AMS.

### DETAILED DESCRIPTION

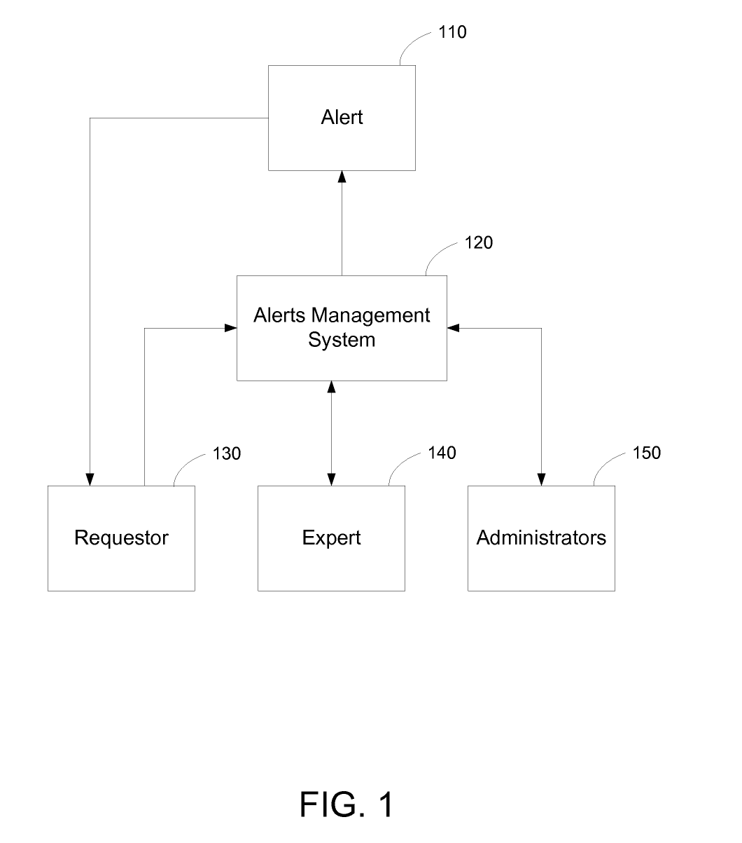

Referring now to the drawings, wherein the showings are for purposes of illustrating one or more exemplary embodiments and not for purposes of limiting same, FIG. 1 illustrates a system including a alert management system (AMS) 120 in accordance with an exemplary embodiment that allows various user types such as requestors 130, experts 140 and administrators 150 to interact with AMS and also an alert 110 in AMS. Users may access AMS 120 utilizing more than one user type role such as a requestor 130, expert 140 or administrator 150 at the same time.

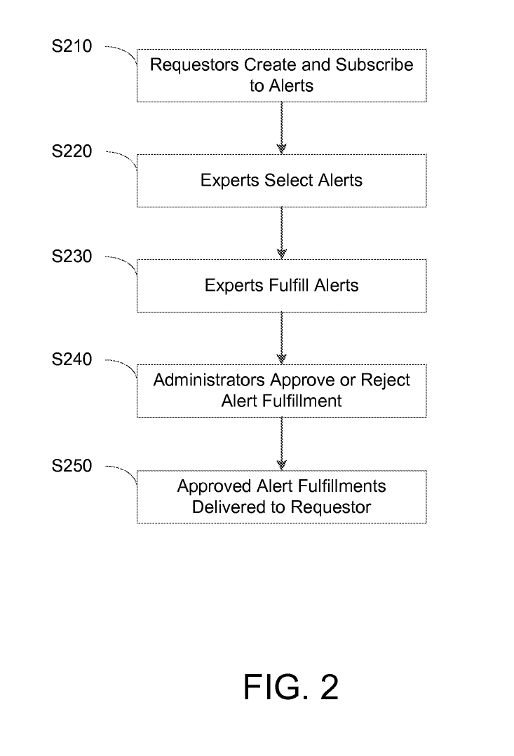

FIG. 2 illustrates an exemplary method in which users can participate in a alert management system. The method of FIG. 2 will be described in association with the system illustrated in FIG. 1, though it is to be appreciated that the method could be used with other systems and/or alert management systems and is not limited to the system and/or AMS 120 shown in FIG. 1.

In the method, a requestor 130 can create and subscribe to alerts 110 they want fulfilled (S210). Requestors may also subscribe to existing alerts created by other users in the system. Once alerts are created in S210, experts 140 select alerts that they intend to fulfill (S220). For each alert, other users in AMS may see the list of experts 140 who intend to fulfill it. Experts fulfill alerts 110 in S230 by creating alert fulfillment information that intend to address the alert request. Administrators 150 approve or reject each alert fulfillment (S240). Rules may also be created in AMS that allow particular experts 140 to have their alert fulfillments automatically approved.

In S250, approved alert fulfillments are delivered to requestors 130 via their choice of delivery method such as to their email address or their mobile phone. Also requestors 130 may specify time intervals in their AMS user profile in which the system may delivery one or more alert fulfillments so they can customize the frequency in which they receive alert fulfillments.

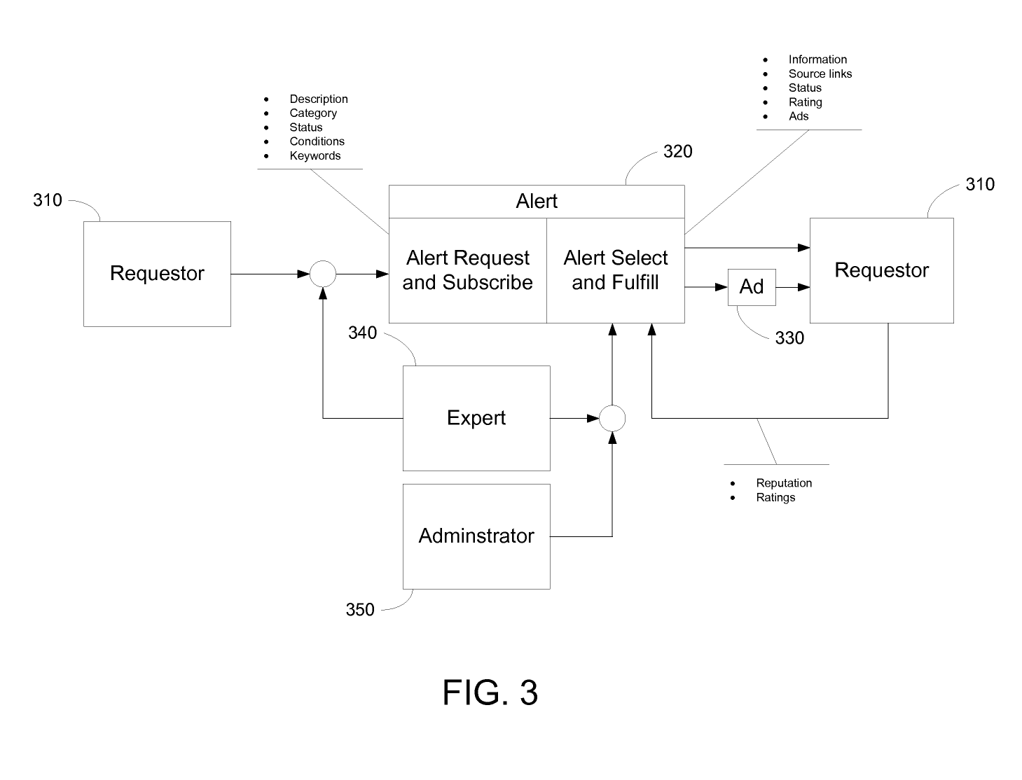

Exemplary alert interaction and management is illustrated in FIG. 3 and described further here. Requestors 310 create alerts 320 by specifying the alert request. An alert 320 may be categorized in one or more categories. The alert request portion of an alert 320 may also contain conditions for the alert to trigger and also a description and keywords of the alert. Requestors 310 can subscribe to existing alerts 320 as well. When users subscribe to an alert, they may specify destination, frequency and time lines to deliver the alert. Experts 340 and administrators 350 can also create alerts 320 so that one or more users may subscribe to it conveniently. Administrators 350 may generally manage alerts 320 for example, by combining similar alerts into one, refining alerts and approving or rejecting alerts. An alert example contains the alert request: “Alert when a particular football team trades a starting player”. Once alerts are available in AMS, experts 340 select alerts 320 that they intend to fulfill.

More than one expert 340 can work on the same alert 320 at the same time. Experts 340 can fulfill an alert 320 by entering fulfillment information on the alert. Alert fulfillment information 320 intend to address the alert request. Optionally the fulfillment information may contain one or more source links that guide the requestor 310 to external relevant information. When an expert fulfills an alert, the alert 320 may go into a “pending approval” or “approved” status depending on the rules set systematically for the alert and the expert.

Alerts 320 may have statuses such as “new”, “active”, “fulfilled”, “partially fulfilled”, “pending approval”, “pending information”, “invalid” and other statuses. There may be more than one alert fulfillment for each alert 320. Administrators 350 may approve or reject alert fulfillments. Administrators 350 may also request more information from the expert 340 before approving the alert for delivery. Administrators 350 will generally manage alert fulfillments. When alert fulfillments of an alert 320 are approved, the alert fulfillment will be delivered to the requestors 310 who are subscribed to that alert. Requestor 310 preferences for delivery destination and time line of alert fulfillments determine how and when the alert is delivered

Time line information can be for example to deliver an alert fulfillment immediately or on a weekly schedule where many approved alert fulfillments are delivered together. The alert fulfillment delivery settings are configurable, such that a user may elect to receive specific alert fulfillments (or all alert fulfillments) on a weekly or immediate basis. Destination information can be for example to deliver the alert to a users email, social network, mobile phone as a notification or mobile text or phone call. There are many delivery settings and time lines a user can specify and is not limited to the examples shown here.

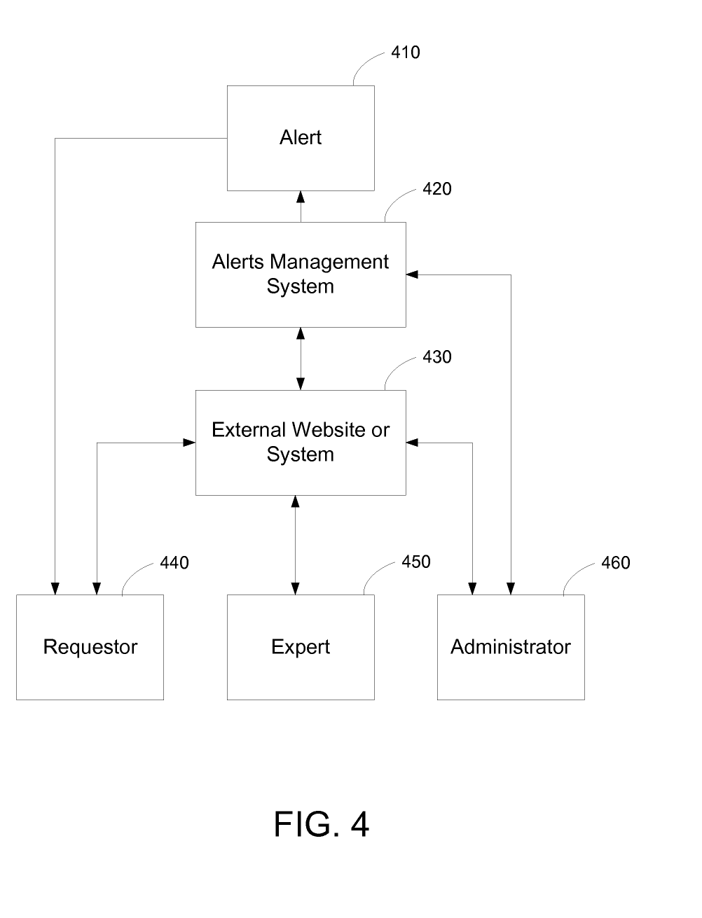

Subscription including delivery information may be defaulted from profile information already stored in AMS for the requestor 310. When an alert fulfillment of an alert 320 is delivered to a requestor 310, the system may deliver an ad 330 to the user alongside the alert fulfillment content. The expert 340 who fulfilled the alert 320 may gain revenue from the ad 330. In cases where the alert was initiated or fulfilled via an external website or system as further described in FIG. 4, the website or system may also gain revenue from the ad 330. A requestor 310 may pay a premium price to get an alert fulfillment or get the alert fulfillment immediately or quicker than other requestors. AMS also provides customizable rules that allow premium pricing. Some of the rules include one or more requestors 310 gaining time advantages in receiving alert fulfillments. The premium price rules can be set by the AMS system, the administrator 350, the requestor 310 or the expert 340. The expert 310, external website or system may also gain revenue based on the premium pricing rules. Requestors 310 can rate or review the alert fulfillment of an alert 320 which contributes to a reputation rating to the expert 340 who created the alert fulfillment. An expert's 340 reputation ratings may be visible to other users in AMS.

An example of reputation management is that the alert “Alert when a particular football team trades a starting player” has fulfillment information that can be rated as accurate or inaccurate. For example, the fulfillment information stated that player one was traded, yet according to the requestor 310, player one was later found not to be traded. The fulfillment information of an alert 320 can also be rated on a scale of 1-5 on the comprehensiveness of the information. For example if the fulfillment only contained the last name of the player traded and not the full name. A rating can also be specified on the sources of the information. For example a user may rate the source of information low when going to the source of information link from the alert fulfillment information and there is no valid information about the traded player at that source. In AMS, there are many such reputation management possibilities on the alert fulfillment of an alert and are not limited to the examples shown here.

With reference to FIG. 4, exemplary external website or system interaction with AMS will now be described. External websites or system 430 representatives may enroll in AMS as administrators 460 and implement AMS 420 on their own website or system 430. External websites or systems may be independently owned or operated by third-parties. There are various methods of accessing the AMS 420 through an external website or system 430. Implementation of external websites 430 may occur via widget technology for example. One such technology is to utilize client-side Javascript code to instantiate and present the user of the external website 430 with an independently interactive frame that contains AMS.

As will be appreciated by those skilled in the art, there are other ways to also implement the AMS system on an external website such that the alert content from AMS is available with independent interactivity on the same web page alongside the external website content. An example of accessing AMS 420 functionality through an external system 430 is where a program running on an operating system accesses AMS 420 through application programming interface (API). Another example of an external system 430 is a mobile device app where AMS 420 is accessed through web services communication between AMS 420 and a mobile device app. The external websites or systems 430 access the functionality of AMS to allow their users to create, subscribe and receive alert fulfillment of alerts 410.

AMS 420 may also directly deliver alert fulfillment of an alert 410 to the requestors 440 of the external website or system. For example, the external website or system would pass the delivery information of their requestor user 440 to AMS and thus allow AMS to deliver the alert fulfillment of the alert 410 directly to the requestor 440. The external website or system 430 access methods to AMS 420 are not limited to the examples here, as there are many ways in which systems can deliver their functionality and services to users. One skilled in the art can appreciate that the full functionality of AMS can be implemented through multiple access methods similar to the ones described here.

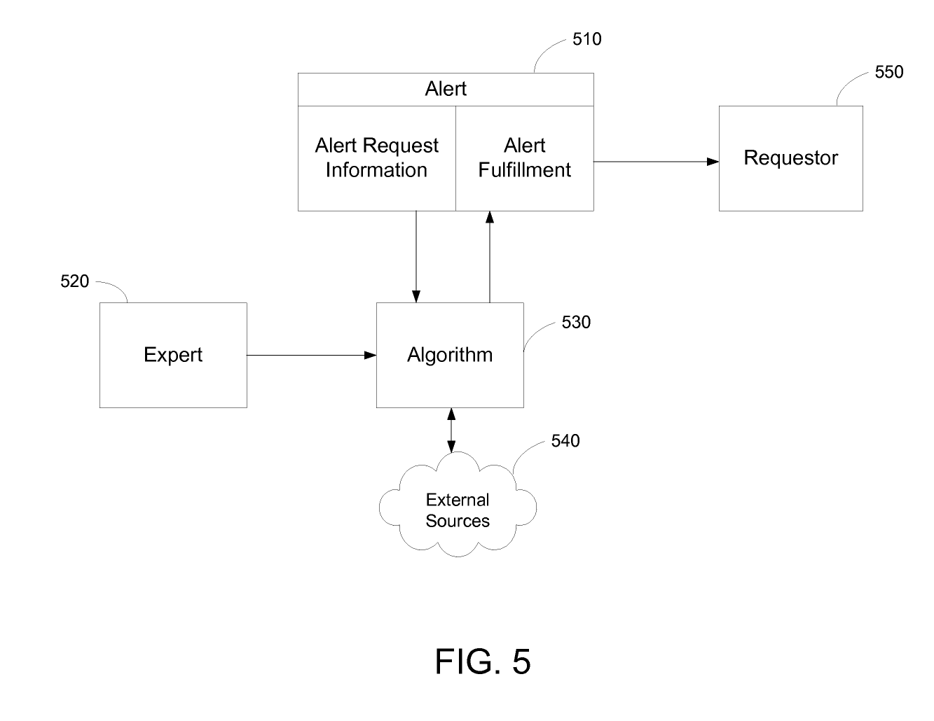

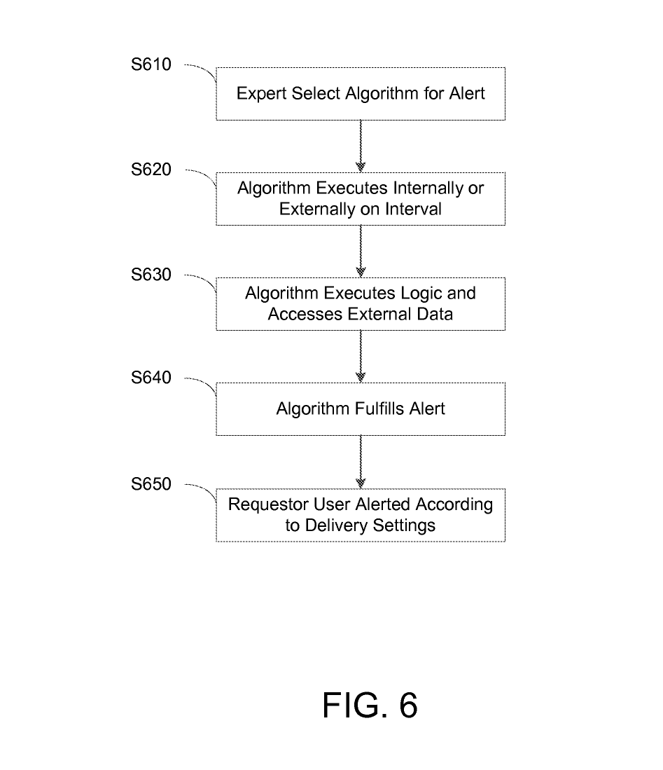

FIG. 5 and FIG. 6 illustrate an exemplary system and method in which algorithms 530, also known as plug-in programming may automatically create alert fulfillment of an alert 510. The method of FIG. 6 will be described in association with the system illustrated in FIG. 5, though it is to be appreciated that the method could be used with other systems and/or alert management systems and not limited to the AMS system. In S610, an expert 520 creates and applies one or more algorithms 530 to an alert 510 in AMS. Then the one or more algorithms 530 executes on an interval basis (S620). The algorithm 530 may be stored and executed within AMS or stored and executed at an external system.

In the internal implementation of an algorithm 530, the AMS system provides interface utilities for an expert 520 to add the algorithm code to AMS. AMS will then automatically execute the algorithm 530 for selected alerts 510 (S630). If the algorithm 530 is stored and executed externally, AMS provides an application programming interface (API) that the external system utilizes to exchange input and output parameters such that the external algorithm may interact with the alerts from AMS to read alert request information and generate the alert fulfillment and thus allow for the execution of the algorithm steps externally (S630).

The algorithm 530 executes programmed logic and may access external sources such as public or private databases or external content (S630). Based on the read information and algorithm steps and logic at S630, if the algorithm determines the alert 510 has been fulfilled, the algorithm 530 will generate an alert fulfillment on the alert (S640). The requestor 550 is alerted at S650 according to the one or more delivery settings of the requestor, alert 510 and AMS. The alert fulfillment may contain links to the external data or statistics of the information or the actual information that the algorithm processed to determine that the alert 510 had been fulfilled.

The algorithms may be implemented by AMS or by third-parties. In one example of an algorithm internal implementation is when an expert 520 uses AMS utilities to add an algorithm 530 that will fulfill the alert 510 to generate an injury alert for a football team. The input to the algorithm 530 is the football team name. Then when the expert 520 selects one or more alerts 510 to be fulfilled by the algorithm 530, the AMS system will execute the algorithm for each alert on the frequency set by the expert. For example if the frequency is set to daily, then AMS will run once a day to execute the algorithm. If for example, the algorithm 530 executes and successfully finds an injured player at a public database, the algorithm will fulfill the alert 510 by adding the player name to the output parameters of the algorithm and thus the alert will be automatically fulfilled by the algorithm executing internally.

Alert request information such as keywords, category or conditions can be optionally supplied as input to any algorithm 530. For example, the particular football team name will be supplied to the algorithm 530. The expert 520 can also optionally specify keywords, categories or conditions as input to the algorithm 530 even if the alert 510 does not contain such information in the alert request.

There are many variations of algorithms 530 possible such as triggering based on advanced rules. An example of an alert 510 that triggers using an advanced rule is when 50% of the external sources the algorithm utilizes contain the name of the same player which may trigger the alert and specify the player as an injured player in the alert fulfillment. The alert fulfillment of an alert 510 when created by an algorithm 530 may still be subject to the alert delivery method, time line and other notification rules.

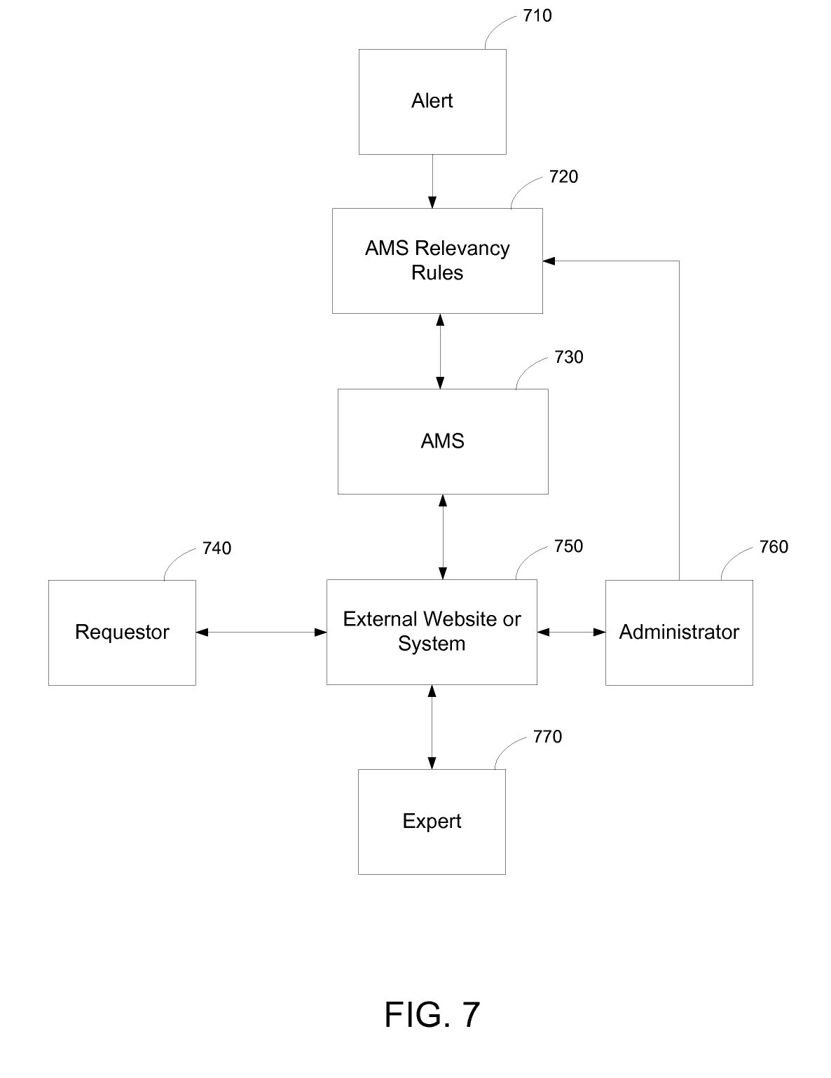

Exemplary relevancy functionality is described here with reference to FIG. 7. When AMS 730 is implemented on a external website or system 750, then AMS may suggest relevant alerts based on the external website or system content that the user is accessing. For example, a user is accessing content at a external website 750 of their favorite football team. In this example AMS 730, which may exist in a widget on the external website, automatically displays a relevant alert 710 related to the favorite football team to the user of the external website. Then the user subscribes to the relevant alert 710 and thus becomes a requestor 740.

AMS 730 can achieve the aforementioned automatic relevancy through several ways. One way is through keyword relevancy such that keywords specific to the external website are generated in advance of or at the time of requestor 740 or expert 770 access to the external website. For example, an AMS 730 process reads the content of the external website 750 and generates keywords based on said content. Utilizing the aforementioned AMS process, keywords for each website 750 are stored in AMS 730 and matched with alerts 710 based on AMS relevancy rules 720. Thus when requestors 740 or experts 770 access AMS 730 through the external website 750, the relevant alerts 710 are displayed to them per website or per web page of the external website.

Each web page of the external website 750 may also pass different keywords or other key data to AMS 730 via other integration methods such that AMS 730 may delivery relevant alerts 710 based on the information passed to it. For example when instantiating the AMS system, the web page of the external website 750 will pass a football team name to AMS in a query parameter so that the alerts 710 related to the football team can be prioritized or filtered.

Another way that AMS 730 may generate relevant content for an external website or system 750 is by prioritizing or filtering alerts most often subscribed, created or fulfilled by previous requestors 740 or experts 770 of the external website or system that interacted with AMS 730. AMS 730 may also generate relevant alerts 710 by allowing website administrators 760 to specify keywords or select specific alerts to prioritize for users of their website or system 750. The website administrator 760 may login to AMS 730 directly or indirectly through the external website or system 750 interaction with AMS 730 to specify the relevancy profile of the external website, system or further for each web page of the external website. AMS 720 may also use a combination of the aforementioned relevancy methods to implement AMS relevancy rules 720 to generate relevant alert 710 interactions for each external website or system 750. The examples for relevancy described here are for illustration and one skilled in the art can appreciate there are many relevancy methods that could be implemented in a system such as AMS.

Referring again to FIG. 4, an external website or system 430 may gain reputation scores based on activity in AMS 420 and said scores may be generally shown to other users in AMS 420. For example experts 450 access AMS 420 through an external website or system 430 to generate alert fulfillments and each expert may gain reputation scores based on the subsequent ratings requestors 440 provide on the said alert fulfillments. Since the experts 450 accessed AMS 420 through the external website or system 430, AMS will calculate a reputation score for the website based on one or more expert ratings of said experts. One example is to calculate the average of the expert ratings of experts 450 as the external website or system 430 reputation score.

The external website or system 430 reputation score may be shown to users subsequently in AMS when said users access AMS directly or through said website or system or through a different external website or system 430.

Alert content generated by experts 450 may be generally prioritized in AMS based on the reputation score of the external system or website 430 of the expert 450.

The example for website reputation scoring described here are for illustration and one skilled in the art can appreciate there are many scoring methods that could be implemented in a system such as AMS.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for managing alert requests and fulfillments, the system comprising:
at least one website having website content hosted on at least one machine server; and
an alert management system (AMS) independent of said website and hosted on at least one server;
wherein said AMS presents alert functionality to users of said website at the time said user is accessing said website, said AMS having a database including a plurality of alerts, and said database further associating at least one website with AMS alert activity.

2. The system of claim 1 further including:
said AMS delivering alerts to users of said website, independently of said website.

3. The system of claim 1 further including:
at least one user of said website providing alert fulfillment in said AMS, independently of said website.

4. The system of claim 1 wherein the AMS is configured to analyze historical activity of users at said website, and configured to prioritize and filter alert content in AMS for subsequent user accesses to AMS at said website.

5. The system of claim 4 wherein the AMS is further configured to deliver alerts to users of said website, independently of said website.

6. The system of claim 4 wherein at least one user of said website provides alert fulfillment in said AMS, independently of said website.

7. A system for managing alert requests and fulfillments, the system comprising:
an alert management system (AMS) hosted on at least one server, said AMS having a database including a plurality of alerts; and
users of said AMS adding at least one algorithm reference to said database, said algorithm reference causing an algorithm to execute on at least one said alert.

8. The system of claim 7 wherein said algorithm reference points to an algorithm stored within said AMS.

9. The system of claim 7 wherein said algorithm reference points to an algorithm not stored within said AMS

10. The system of claim 7 further including:
at least one website having website content hosted on at least one machine server, said AMS independent of said website, and wherein said AMS presents alert functionality to users of said website at the time said user is accessing said website, and further wherein said AMS has a database including a plurality of alerts, said database further associating at least one website with AMS alert activity.

11. A system for managing alert requests and fulfillments, the system comprising:
an alert management system (AMS) hosted on at least one server, said AMS having a database including a plurality of alerts;
at least one expert user of said AMS adding alert fulfillment in said AMS;
at least two users of said AMS rating the said alert fulfillment after having received the alert fulfillment as a notification to generate a reputation for said expert user, wherein said expert user reputation generally visible to users of said AMS.

12. The system of claim 11 wherein sail alert fulfillments are prioritized or filtered based on said two or more expert user reputations.

13. The system of claim 12 further including:
at least one website having website content hosted on at least one machine server with said AMS independent of said website, said AMS presenting alert functionality to users of said website at the time said users are accessing said website, and said AMS prioritizing or filtering alert content to users of said website based on said two or more expert user reputations.

14. The system of claim 11 further including:
at least one website having website content hosted on at least one machine server with said AMS independent of said website, said AMS presenting alert functionality to users of said website at the time said users are accessing said website, at least one expert user of said website adding alert fulfillment in said AMS, at least two users of said AMS, rating the said alert fulfillment after having received the alert fulfillment as a notification to generate a reputation for said expert user.

15. The system of claim 14 wherein the AMS is configured to calculate reputation score for said website based on one or more said expert users of said website, and is further configured to display said reputation score generally in AMS for said website.
